(19) United States
(12) Patent Application Publication
(10) Pub. No.: US 2026/0264415 A1
(43) Pub. Date: Sep. 10, 2026

(54) IMAGE FORMATION APPARATUS AND CONTROL METHOD

(71) Applicant: Kaname Iga, Izunokuni Shizuoka (JP)

(72) Inventor: Kaname Iga, Izunokuni Shizuoka (JP)

(73) Assignee: ETRIA Co., Ltd., Kanagawa (JP)

(21) Appl. No.: 19/449,290

(22) Filed: Jan. 14, 2026

(30) Foreign Application Priority Data
Mar. 10, 2025 (JP) 2025-037687

(51) Int. Cl. B41J 2/355; B41J 3/46; G06K 15/02

(52) U.S. Cl. CPC B41J 2/355; B41J 3/46; G06K 15/028; G06K 15/1803

(57) ABSTRACT

An image formation apparatus having a thermal head including a heat-generating body and a driver IC (integrated circuit) provided with at least one logic circuit that controls operations of the heat-generating body, and a controller that performs a determination regarding whether or not a digital operation voltage Vdd, capable of driving the at least one logic circuit, is being applied to the at least one logic circuit.

### CROSS-REFERENCE TO RELATED APPLICATION

This application is based upon and claims the benefit of priority from Japanese Patent Application No. 2025-037687, filed Mar. 10, 2025, the entire content of which is incorporated herein by reference.

### FIELD

The present disclosure relates to an image formation apparatus and a control method.

### BACKGROUND

Conventionally, image formation apparatuses on which thermal heads are mounted, such as thermal printers, portable printers, and the like are known.

Conventionally, there was no way to check whether a digital operation voltage Vdd of a logic circuit in a driver IC (integrated circuit) mounted on a thermal head was being correctly supplied. As a result thereof, there were cases in which the head driving voltage was applied in a state in which the digital operation voltage Vdd was not correctly supplied, thereby damaging the head.

The problem to be solved by the present disclosure is to provide an image formation apparatus and a control method, the image formation apparatus being provided with a thermal head and being capable of detecting the supply state of a digital operation voltage Vdd.

### BRIEF DESCRIPTION OF THE DRAWINGS

FIG. 1 is an external view illustrating the configuration of an image formation apparatus of an embodiment.

FIG. 2 is a first side view illustrating an example of the internal configuration of an image formation apparatus of an embodiment.

FIG. 3 is a second side view illustrating an example of the internal configuration of an image formation apparatus of an embodiment.

FIG. 4 is a block diagram illustrating an example of the system configuration of an image formation apparatus of an embodiment.

FIG. 5 is a circuit diagram illustrating an example of a circuit associated with control of a thermal head in an embodiment.

FIG. 6 is a flow chart illustrating an example of the flow of a process executed by an image formation apparatus in an embodiment.

FIG. 7 is a diagram illustrating a first example of the positions of SVdd nodes in a modification example.

FIG. 8 is a diagram illustrating a second example of the positions of SVdd nodes in a modification example.

### DETAILED DESCRIPTION

An image formation apparatus in an embodiment has a thermal head provided with a heat-generating body and a driver IC (integrated circuit) provided with at least one logic circuit that controls operations of the heat-generating body, and a controller (hereinafter also referred to as a control unit) configured to perform a determination regarding whether or not a digital operation voltage Vdd, capable of driving the at least one logic circuit, is being applied to the at least one logic circuit.

Hereinafter, the image formation apparatus of the embodiment will be explained with reference to the drawings. As used throughout this disclosure, the singular forms "a", "an", and "the" include plural reference unless the context clearly dictates otherwise.

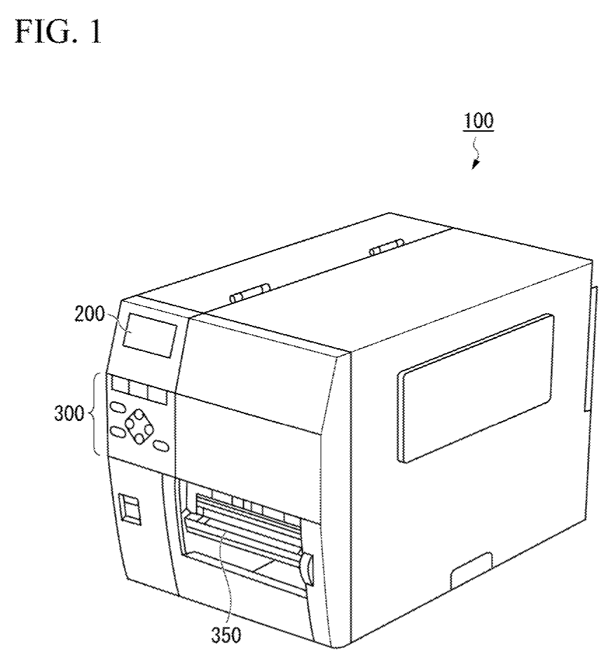

FIG. 1 is an external view illustrating an example of the configuration of an image formation apparatus 100 of an embodiment. The image formation apparatus 100 may be any type of image formation apparatus as long as it is an image formation apparatus provided with a thermal head, and for example, may be a thermal printer, or may be a portable printer.

The image formation apparatus 100 prints a prescribed image on a label and issues the label on which the image has been printed. The image formation apparatus 100 has a high-speed printing function. The high-speed printing function is a function that allows printing to be performed at a printing speed (second printing speed) that is faster than a printing speed (first printing speed) for normal printing. That is, in the high-speed printing function, the label conveyance speed is faster, at low speed, than the conveyance speed at low speed for normal printing. The image formation apparatus 100 is provided with a display unit 200, an operation unit 300, and a discharge port 350, as illustrated in FIG. 1.

The display unit 200 is an image display apparatus such as a liquid crystal display or an organic EL (electroluminescence) display. The display unit 200 operates as an output interface and displays text or images. Additionally, the display unit 200 may operate as an input interface to receive inputs of instructions from a user.

The operation unit 300 is configured by using existing input apparatuses such as buttons. The operation unit 300 is operated by a user when inputting user instructions to the image formation apparatus 100. For example, the operation unit 300 receives inputs of instructions to start printing. For example, the operation unit 300 receives inputs of normal printing instructions or high-speed printing instructions from the user.

The discharge port 350 discharges labels on which images are printed.

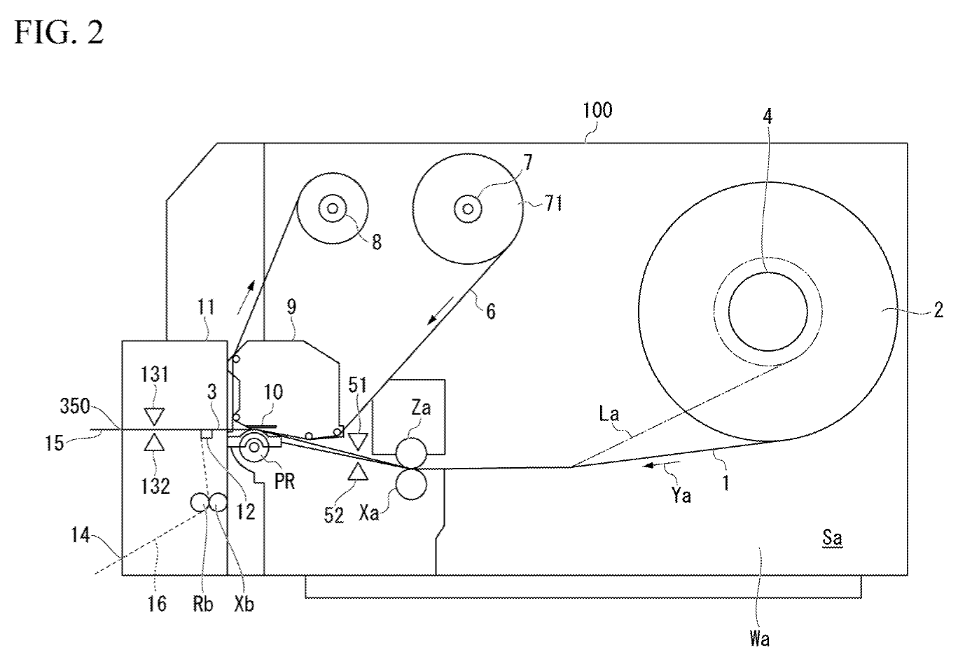

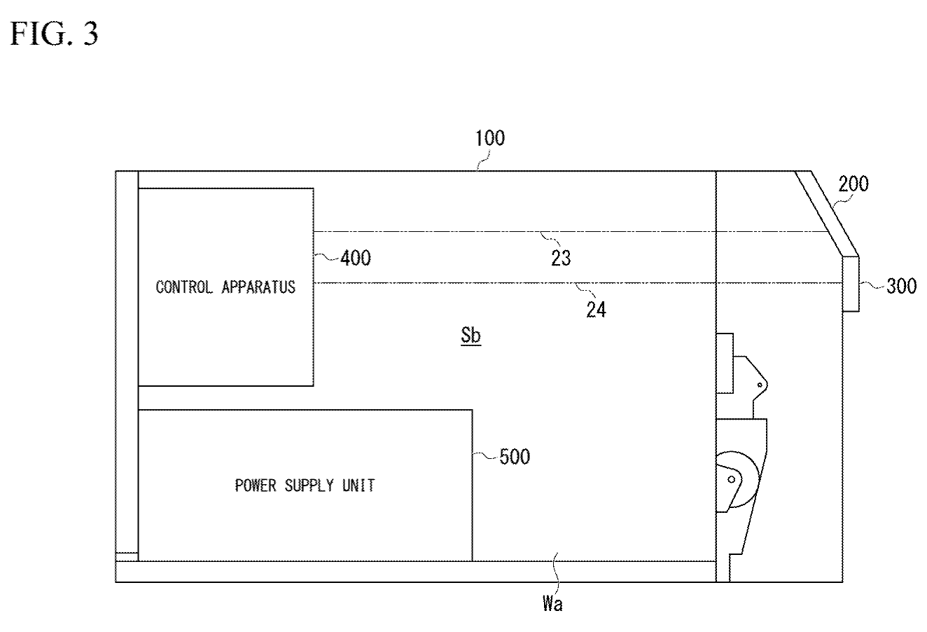

FIG. 2 and FIG. 3 are side views illustrating an example of the internal configuration of an image formation apparatus 100 of an embodiment. FIG. 2 and FIG. 3 illustrate drawings of the internal configuration of the image formation apparatus 100 from respectively different side views. As illustrated in FIG. 2 and FIG. 3, the image formation apparatus 100 has a first chamber Sa and a second chamber Sb inside a housing. The first chamber Sa and the second chamber Sb are partitioned by a vertical wall Wa. First, FIG. 2 will be used to explain the configuration in the first chamber Sa.

Inside the first chamber Sa, label roll paper 1, a pinch roller Xa, a conveyance roller Za, a sheet detection sensor 51, a sheet detection sensor 52, an ink ribbon 6, an ink ribbon supply shaft 7, an ink ribbon winding shaft 8, a platen roller PR, a printing head 9, a thermal head 10, and a peeling unit 11 are provided.

The label roll paper 1 is label paper formed by affixing multiple labels to ribbon-shaped backing paper. The label roll paper 1 is wound in the shape of a roll to form a roll portion 2. The label roll paper 1 is conveyed to a conveyance path 3 by being drawn out from the roll portion 2.

Additionally, the label roll paper 1 indicated by the solid line in FIG. 2 illustrates the label roll paper in a state in which the diameter of the roll portion 2 is relatively large. Meanwhile, the single-dotted chain line La in FIG. 2 indicates the position of the label roll paper in a state in which the diameter of the roll portion 2 has become relatively small. Additionally, the arrow Ya illustrated in FIG. 2 indicates the feedout direction of the label roll paper 1.

The pinch roller Xa is arranged opposite the conveyance roller Za. The conveyance roller Za is driven by a motor that is not illustrated. The pinch roller Xa and the conveyance roller Za convey the label roll paper 1, which is backing paper bearing labels.

The sheet detection sensor 51 is a radiation unit that irradiates the conveyance path 3 with light. The sheet detection sensor 52 is a light-receiving unit that receives the light radiated from the sheet detection sensor 51. The sheet detection sensor 52 detects a voltage level in accordance with the amount of light that has been received. The sheet detection sensor 52 detects labels in accordance with the detected voltage level. When the detected voltage level is less than a threshold value, the sheet detection sensor 52 detects a label. Conversely, when the detected voltage level is equal to or higher than the threshold value, the sheet detection sensor 52 does not detect a label. The sheet detection sensor 52 outputs detection results to a control apparatus 400. The detection results include whether or not a label has been detected. The sheet detection sensor 52 outputs the detection results periodically or at preset timings. The sheet detection sensor 51 and the sheet detection sensor 52 are, for example, transmissive sensors. Additionally, in the explanation below, when not particularly distinguishing between the sheet detection sensor 51 and the sheet detection sensor 52, they will be referred to as sheet detection sensors 5.

The ink ribbon 6 is a tape-type ink cartridge. The ink ribbon 6, together with the label roll paper 1, is sandwiched between the thermal head 10 and the platen roller PR. Ink from the ink ribbon 6 is transferred to the label roll paper 1 by heat applied from the thermal head 10.

The ink ribbon supply shaft 7 is a shaft that feeds out the ink ribbon 6. The supply shaft 7 is provided on the feedout-side of the ink ribbon 6. A roll portion 71 of the ink ribbon 6 is set on the supply shaft 7. Hereinafter, the roll portion 71 of the ink ribbon 6 will be described as a ribbon roll. The supply shaft 7 is rotationally driven by a rotational driving mechanism including a DC motor, a gear, a belt, etc.

The ink ribbon winding shaft 8 is a shaft for winding up the ink ribbon 6. The winding shaft 8 is provided on the windup-side of the ink ribbon 6. The winding shaft 8 is rotationally driven by a rotational driving mechanism including a DC motor, a gear, a belt, etc. The rotation of the winding shaft 8 causes the ink ribbon 6 to be wound onto the winding shaft 8 and drawn out from the ribbon roll.

The platen roller PR is rotationally driven by a rotational driving mechanism, not illustrated, that includes an unillustrated motor, such as a stepping motor, a gear, a belt, etc. The platen roller PR is arranged opposite the thermal head 10 provided on the printing head 9.

The printing head 9 is provided with a thermal head 10. The printing head 9 presses the label roll paper 1 that is conveyed between the thermal head 10 and the platen roller PR against the platen roller PR.

The thermal head 10 is arranged opposite the platen roller PR above the platen roller PR. The thermal head 10 uses the ink ribbon 6 to print onto the labels affixed to the backing paper of the label roll paper 1 that has been conveyed. The thermal head 10 has multiple heat-generating elements that are arranged in a row. The heat-generating elements generate heat by application of electric power. The thermal head 10 selectively applies electric power to multiple heat-generating elements, thereby causing the heat-generating elements to generate heat. The thermal head 10 prints by melting or sublimating the ink on the ink ribbon 6 by generating heat from the heat-generating elements, and transferring the ink to the labels.

The peeling unit 11 is an apparatus that peels labels from the label roll paper 1 that has been conveyed on the conveyance path 3. The peeling unit 11 is provided with a peeling bar 12, a peeling sensor 131, a peeling sensor 132, a discharge port 14, a discharge port 15, a pinch roller Xb, and a conveyance roller Rb.

The peeling bar 12 is in the form of a flat plate and is provided basically at a right angle in front of the thermal head 10, i.e., forward in the feeding direction of the label roll paper 1.

The peeling sensor 131 is a radiation unit that irradiates the conveyance path 3 with light. The peeling sensor 132 is a light-receiving unit that receives the light radiated from the peeling sensor 131. The peeling sensor 132 detects a voltage level in accordance with the amount of light that has been received. The peeling sensor 132 detects labels in accordance with the detected voltage level. When the detected voltage level is less than a threshold value, the peeling sensor 132 detects a label.

Conversely, when the detected voltage level is equal to or higher than the threshold value, the peeling sensor 132 does not detect a label. The peeling sensor 132 outputs detection results to the control apparatus 400. The detection results include whether or not a label has been detected. The peeling sensor 132 outputs the detection results periodically or at preset timings. The peeling sensor 131 and the peeling sensor 132 are, for example, transmissive sensors. Additionally, in the explanation below, when not particularly distinguishing between the peeling sensor 131 and the peeling sensor 132, they will be referred to as peeling sensors 13.

The discharge port 14 is a discharge port from which the backing papers 16, from which the labels have been peeled by the peeling bar 12, are discharged.

The pinch roller Xb is arranged opposite the conveyance roller Rb.

The conveyance roller Rb is driven by a motor, which is not illustrated. The conveyance roller Rb is driven by a motor, which is not illustrated. The pinch roller Xb and the conveyance roller Rb convey the backing paper 16 from which the labels have been peeled.

Next, FIG. 3 will be used to explain the configuration inside the second chamber Sb.

As illustrated in FIG. 3, the second chamber Sb is provided with a control apparatus 400 and a power supply unit 500.

The control apparatus 400 controls the operations of the image formation apparatus 100 overall. For example, the control apparatus 400 controls the conveyance of the label roll paper 1 by controlling the motors of the conveyance roller Za, the conveyance roller Rb, and the platen roller PR. More specifically, the control apparatus 400 controls the conveyance speed of the label roll paper 1 by controlling the motors of the conveyance roller Za, the conveyance roller Rb, and the platen roller PR. Additionally, the control apparatus 400 controls the thermal head 10 to print data that is to be printed (hereinafter referred to as "printing data") onto the labels on the backing paper of the label roll paper 1.

The power supply unit (PSU) 500 supplies power to the image formation apparatus 100. The dashed line 23 represents the path traveled by data between the display unit 200 and the control apparatus 400 provided in the image formation apparatus 100. The dashed line 24 represents the path traveled by data between the control apparatus 400 and the operation unit 300.

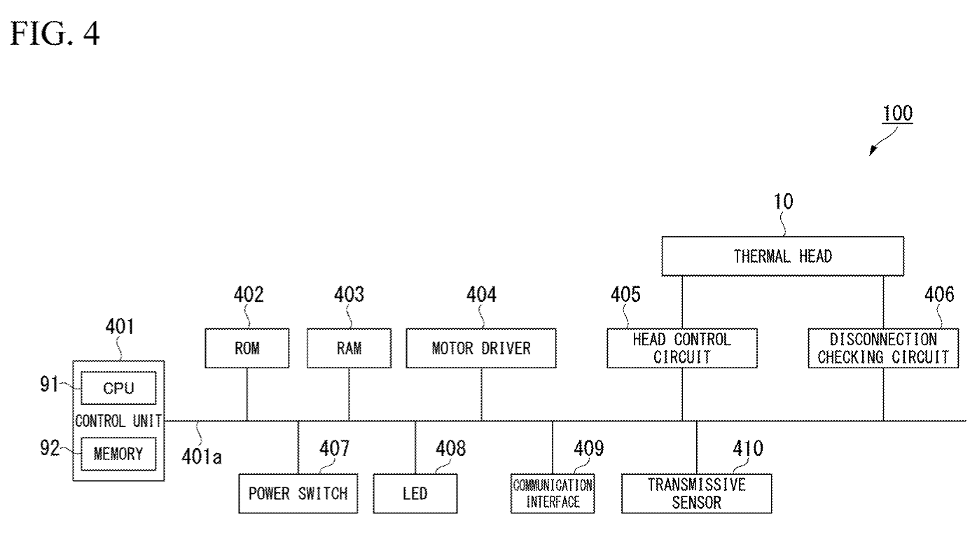

FIG. 4 is a block diagram illustrating an example of a system configuration of the image formation apparatus 100 of an embodiment. The image formation apparatus 100 is provided with a control unit 401, a ROM (read-only memory) 402, a RAM (random access memory) 403, a motor driver 404, a head control circuit 405, a disconnection checking circuit 406, a power switch 407, an LED (light-emitting diode) 408, a communication interface 409, a transmissive sensor 410, and a thermal head 10. The respective functional units are connected by a bus 401a.

The control unit 401 is provided with a memory 92 and a processor 91 such as a CPU (central processing unit), a GPU (graphics processing unit), or an NPU (neural network processing unit) connected by a bus, and executes a program.

By executing the program, the control unit 401 controls the respective functional units of the image formation apparatus 100. Additionally, the control unit 401 stores information regarding prescribed distances. The information regarding prescribed distances includes the distance from the transmissive sensor 410 to the thermal head 10 or the distance of the gap between labels.

The ROM 402 is a memory that is exclusively for reading, and has a program for operating the image formation apparatus 100 prestored therein.

The RAM 403 is a read/write memory that stores various types of information. The program read out from the ROM 402 is loaded in the RAM 403. Additionally, the RAM 403 stores various types of data (for example, printing data, etc.) generated by the program being executed.

The motor driver 404 drives a motor (not illustrated) for conveying paper sheets. In the image formation apparatus 100, the paper sheets are labels affixed to ribbon-shaped backing paper. The motor driver 404 controls the conveyance speed of the paper sheets by controlling the torque of the motor.

The head control circuit 405 performs power connection control to the thermal head 10.

The disconnection checking circuit 406 checks for disconnections in the heat-generating elements constituting the thermal head 10. The head control circuit 405 is connected to the disconnection checking circuit 406.

The power switch 407 is turned on/off mechanically and by software. By software means being turned on/off by a control signal of the image formation apparatus 100.

The LED 408, by being controlled by the control unit 401, emits light of different colors in accordance with the voltage state of a secondary battery (not illustrated).

The communication interface 9 is an interface for communication between the image formation apparatus 100 and another apparatus different from the image formation apparatus 100. The other apparatus is, for example, a host computer (not illustrated). The other apparatus may be a speaker (not illustrate) or may be a storage apparatus (not illustrated).

The transmissive sensor 410 detects paper sheets. For example, the transmissive sensor 410 detects a label edge on a paper sheet. The transmissive sensor 410 is composed of a radiation unit and a light-receiving unit. The radiation unit radiates light. The light-receiving unit receives light radiated from the radiation unit and detects a voltage level in accordance with the amount of received light. Furthermore, the light-receiving unit detects label edges on the paper sheet in accordance with the detected voltage level. Specifically, when the detected voltage level is less than a threshold value, the light-receiving unit detects a label edge on the paper sheet.

Conversely, when the detected voltage level is equal to or higher than the threshold value, the light-receiving unit does not detect a label edge on the paper sheet. The transmissive sensor 410 outputs detection results to the control unit 401. The detection results include whether or not a label edge has been detected. The transmissive sensor 410 outputs detection results periodically or at preset timings.

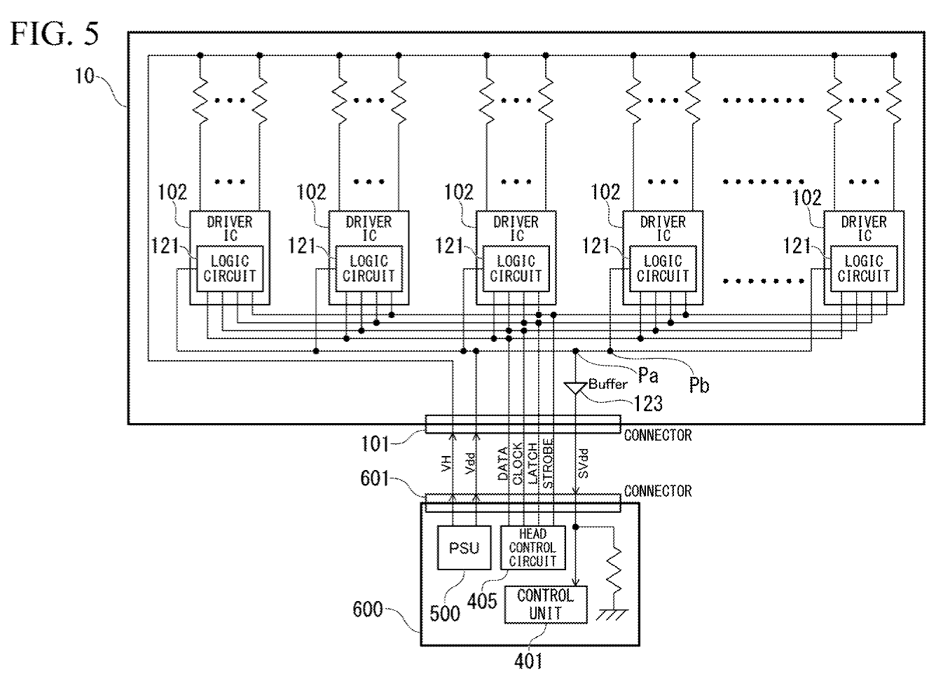

FIG. 5 is a circuit diagram illustrating an example of a circuit associated with control of the thermal head 10 in an embodiment. FIG. 5 illustrates the thermal head 10 and a printer control board 600. The printer control board 600 is provided with a head control circuit 405, a control unit 401, a power supply unit 500, and a connector 601.

The connector 601 is one of a pair of components electrically connecting the printer control board 600 with the thermal head 10, and is the one that is attached to the printer control board 600 side. Therefore, the connector 601 is a so-called connector, and is a connector that is attached to the printer control board 600 side in the image formation apparatus 100.

The electric power output by the power supply unit 500 flows through the connector 601 and the connector 101 to the thermal head 10. The connector 101 is one of the pair of components electrically connecting the printer control board 600 with the thermal head 10, and is the one that is attached to the thermal head 10 side. Therefore, the connector 101 is a so-called connector, and is a connector that is attached to the thermal head 10 in the image formation apparatus 100. The connector 601 and the connector 101 form a pair.

Signals flowing between the head control circuit 405 and the thermal head 10 flow through the connector 601 and the connector 101, and flow from one to the other or from the other to the one.

The thermal head 10 is provided with one or a plurality of driver ICs 102. The driver ICs 102 are driver ICs (integrated circuits) that control the operations of the heat-generating bodies. Digital operation voltages Vdd are applied to the driver ICs 102. The digital operation voltages Vdd are applied to the driver ICs 102 by the power supply unit 500. Therefore, at least some of the electric power output by the power supply unit 500 is supplied to the driver ICs 102 as electric power at the digital operation voltages Vdd.

The driver ICs 102 are provided with logic circuits 121. The digital operation voltages Vdd applied to the driver ICs 102 by the power supply unit 500 are specifically applied to the logic circuits 121. The logic circuits 121 are logic circuits that control the operation of the heat-generating bodies.

The electric power at the voltage VH output from the power supply unit 500 in FIG. 5 is defined as a heat-generating-body driving power. This voltage VH is applied to the driver ICs 102.

DATA signals, CLOCK signals, LATCH signals, and STROBE signals flow between the head control circuit 405 and the logic circuits 121. The DATA signals are signals that are transmitted from the head control circuit 405 towards the logic circuits 121, and are signals representing instructions to the head control circuit 405. The CLOCK signals are signals indicating a synchronization clock. The CLOCK signals are used for sending the DATA signals.

The LATCH signals are signals indicating the ending of the CLOCK signals and the starting of the STROBE signals. The STROBE signals are signals indicating whether or not electric power is to be made to flow to the heat-generating bodies. The digital operation voltages Vdd are also used in these signals.

The control unit 401 and the logic circuits 121 are connected by conductive lines. More specifically, the conductive lines (hereinafter referred to as "Vdd lines") connecting the power supply unit 500 with the logic circuits 121 are connected to the control unit 401 at SVdd nodes. More specifically, the control unit 401 is connected with the logic circuits 121 by the conductive lines (hereinafter referred to as "SVdd lines") connecting the control unit 401 with the SVdd nodes.

The SVdd nodes are prescribed positions on the Vdd lines. The Svdd nodes may be, for example, prescribed positions on the Vdd lines, though not at the ends. The ends of the Vdd lines are positions at the power supply unit 500 or at the logic circuits 121. The node Pa in the example in FIG. 5 is an example of an SVdd node.

Signals flowing through the SVdd lines (hereinafter referred to as "SVdd signals") flow into the control unit 401.

### Determination by control unit 401

The control unit 401 performs a determination process. The determination process is a process for performing a determination, based on an SVdd signal, regarding whether or not a digital operation voltage Vdd capable of driving a logic circuit 121 is being applied to the logic circuit 121. For example, in the determination process, the control unit 401 performs a determination regarding whether or not a digital operation voltage Vdd capable of driving a logic circuit 121 is being applied to the logic circuit 121 based on the signal level of an SVdd signal.

For example, in the case in which the signal level of the SVdd signal is equal to or higher than a prescribed magnitude, the control unit 401 determines that a digital operation voltage Vdd capable of driving the logic circuit 121 is being applied to the logic circuit 121. In the case of the example of the circuit configuration in FIG. 5, this determination is, more specifically, a determination that digital operation voltages Vdd, capable of driving all of the logic circuits 121 provided in the thermal head 10, are being applied.

Conversely, in the case in which the signal level of the SVdd signal is less than the prescribed magnitude, the control unit 401 determines that a digital operation voltage Vdd capable of driving the logic circuit 121 is not being applied to the logic circuit 121. A number of examples of more specific content relating to this determination will be indicated. In the case of the example of the circuit configuration in FIG. 5, this determination is, more specifically, a determination that a digital operation voltage Vdd capable of driving is not being applied to at least some of the logic circuits 121 among the logic circuits 121 provided in the thermal head 10.

In the example in FIG. 5, the thermal head 10 is provided with a buffer 123. The buffer 123 converts the Vdd power supply to a detection signal, and as a result thereof, provides the effect of allowing a pull-down circuit to be added to a PPAS signal.

The feature of providing the buffer 123 will be explained. For example, when the Vdd electric power is not being supplied and the buffer input is unstable, there is a possibility that the electric potential will not be able to be detected on the printer side. At this time, if there is a pull-down on the PPAS signal, the output of the buffer will go to GND level and an abnormality can be detected. When the Vdd electric power is directly connected, an intermediate electric potential is obtained. The buffer output at a normal time is the output from a CMOS (complementary metal-oxide-semiconductor) circuit, which is 5 V (H level), and even if there is a circuit with a pull-down resistor (for example, 10 KΩ), the PPAS detection signal is H, and it can be detected that the situation is normal.

In the example in FIG. 5, the node Pa is located on the thermal head 10. In this way, the SVdd nodes may, for example, be located in the thermal head 10.

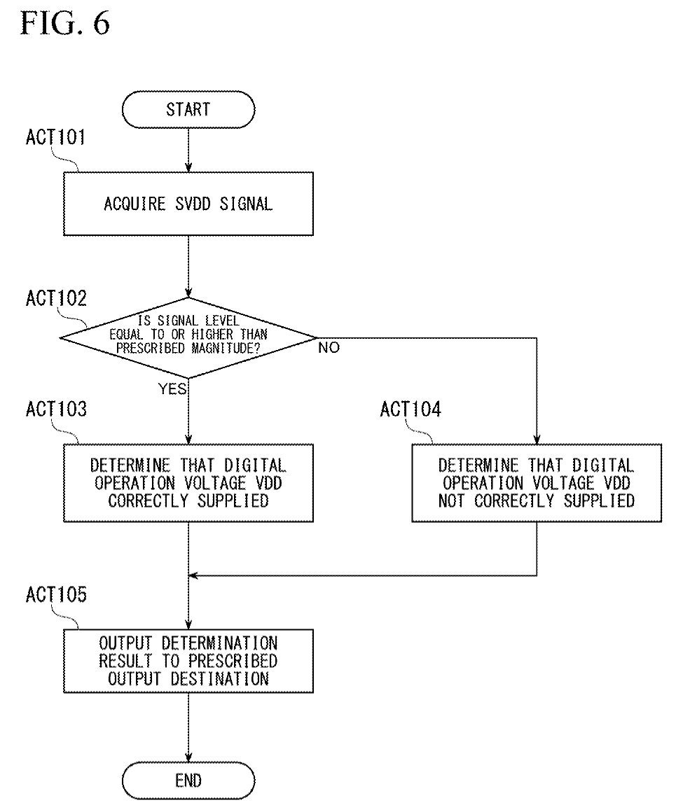

FIG. 6 is a flow chart indicating an example of the flow of processes executed by the image formation apparatus 100 in an embodiment. In this case, an explanation will be provided by using an example of a determination process for determining whether or not a digital operation voltage Vdd capable of driving a logic circuit 121 is being applied based on whether or not the signal level of the SVdd signal is equal to or higher than a prescribed magnitude.

The control unit 401 acquires an SVdd signal (ACT101). Next, based on the acquired SVdd signal, the control unit 401 determines whether or not the signal level of the SVdd signal is equal to or higher than a prescribed magnitude (ACT102).

In the case in which the signal level of the SVdd signal is equal to or greater than the prescribed magnitude (ACT102: YES), the control unit 401 determines that the digital operation voltage Vdd is being correctly supplied (ACT 103). That is, the control unit 401 determines that a digital operation voltage Vdd capable of driving the logic circuit 121 is being applied to the logic circuit 121.

Conversely, in the case in which the signal level of the SVdd signal is less than the prescribed magnitude (ACT102: NO), the control unit 401 determines that the digital operation voltage Vdd is not being correctly supplied (ACT104). That is, the control unit 401 determines that a digital operation voltage Vdd capable of driving the logic circuit 121 is not being applied to the logic circuit 121.

Next, the control unit 401 outputs the determination result obtained in step S103 or step S104 to a prescribed output destination that is communicably connected to the control unit 401 and that is controllable by the control unit 401 (ACT105). The prescribed output destination is, for example, the display unit 200. The control unit 401 may control the operations of the display unit 200 and cause the determination result obtained in step S103 or step S104 to be displayed on the display unit 200.

The prescribed output destination may, for example, be connected to the control unit 401 via the communication interface 9. Therefore, the prescribed output destination may be, for example, a host computer, may be a speaker, or may be a storage apparatus. When the control unit 401 outputs a determination result, the speaker reads the determination result as speech. When the control unit 401 outputs a determination result, the storage apparatus stores the determination result.

The image formation apparatus 100 configured in this manner has a thermal head 10 and a control unit 401. The thermal head 10 is provided with a heat-generating body and a driver IC 102 provided with a logic circuit 121 that controls the operations of the heat-generating body. The control unit 401 performs a determination regarding whether or not a digital operation voltage Vdd capable of driving the logic circuit 121 is being applied to the logic circuit 121. For this reason, the image formation apparatus 100 is an image formation apparatus provided with a thermal head and can detect the supply state of the digital operation voltage Vdd.

### Modification examples

In the case in which the thermal head 10 is provided with a plurality of logic circuits 121, the control unit 401 may perform a determination for each logic circuit 121 that is a determination target. The determination targets may be all or a prescribed portion of the plurality of logic circuits 121 provided in the thermal head 10.

In the case in which there are a plurality of logic circuits 121 that are determination targets, a determination may be made for each of the logic circuits 121 that are determination targets, for example, in the case in which the Vdd lines connecting the power supply unit 500 with the determination targets are different for each of the determination targets and they have no portions in common with each other. In this case, there is an SVdd node for each determination target, and the SVdd lines also differ for each SVdd node and do not have portions in common with each other.

The case in which there is one determination target will also be explained. The determination for each logic circuit 121 that is a determination target in this case may be made, for example, when the Vdd line connecting the power supply unit 500 with the determination target is different from those of other logic circuits 121 and they have no portions in common with each other. In this case, the Vdd lines connecting other logic circuits 121 with the power supply unit 500 may be different for each of the other logic circuits 121 and may have no portions in common with each other, or they may have portions in common.

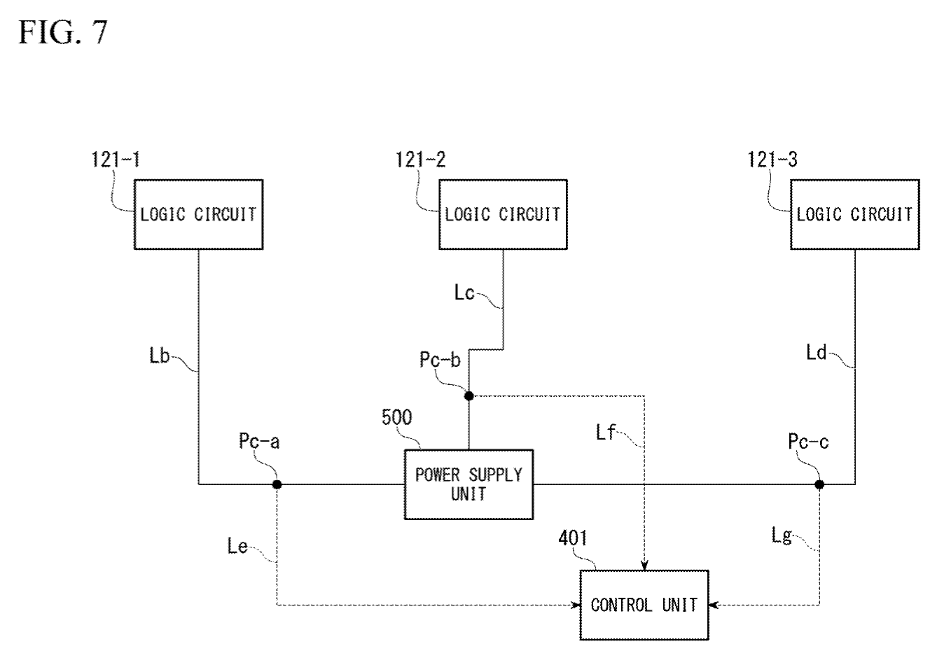

FIG. 7 indicates a first example of the positions of SVdd nodes in a modification example. In the example in FIG. 7, in order to simplify the explanation, there are three logic circuits 121 connected to the power supply unit 500. In the example in FIG. 7, the three logic circuits 121-1 to 121-3 are connected to the power supply unit 500. However, the Vdd lines connecting the respective logic circuits 121 with the power supply unit 500 are different from each other and do not have any portions in common.

Furthermore, there is also an SVdd node on each conductive line. Specifically, there is an SVdd node Pc-a, an SVdd node Pc-b, and an SVdd node Pc-c. The SVdd node Pc-a is an SVdd node positioned on the Vdd line connecting the logic circuit 121-1 with the power supply unit 500. The SVdd node Pc-b is an SVdd node positioned on the Vdd line connecting the logic circuit 121-2 with the power supply unit 500. The SVdd node Pc-c is an SVdd node positioned on the Vdd line connecting the logic circuit 121-3 with the power supply unit 500.

Furthermore, each of the SVdd nodes Pc-a to Pc-c is connected to the the control unit 401 by a conductive line. Therefore, in this case, the control unit 401 performs the determination process for each of the SVdd signals flowing through the respective SVdd lines. As a result thereof, the control unit 401 determines whether or not a digital operation voltage Vdd capable of driving the logic circuit 121-1 is being applied to the logic circuit 121-1.

Additionally, the control unit 401 determines whether or not a digital operation voltage Vdd capable of driving the logic circuit 121-2 is being applied to the logic circuit 121-2. The control unit 401 also determines whether or not a digital operation voltage Vdd capable of driving the logic circuit 121-3 is being applied to the logic circuit 121-3.

In the case of the example in FIG. 7, for example, if the only determination target is the logic circuit 121-1, there is no need for the control unit 401 to perform the determination process for the logic circuit 121-2 and the logic circuit 121-3.

Each of the conductive line Lb, the conductive line Lc, and the conductive line Ld in FIG. 7 is an example of a Vdd line. Additionally, each of the conductive line Le, the conductive line Lf, and the conductive line Lg is an example of an SVdd line.

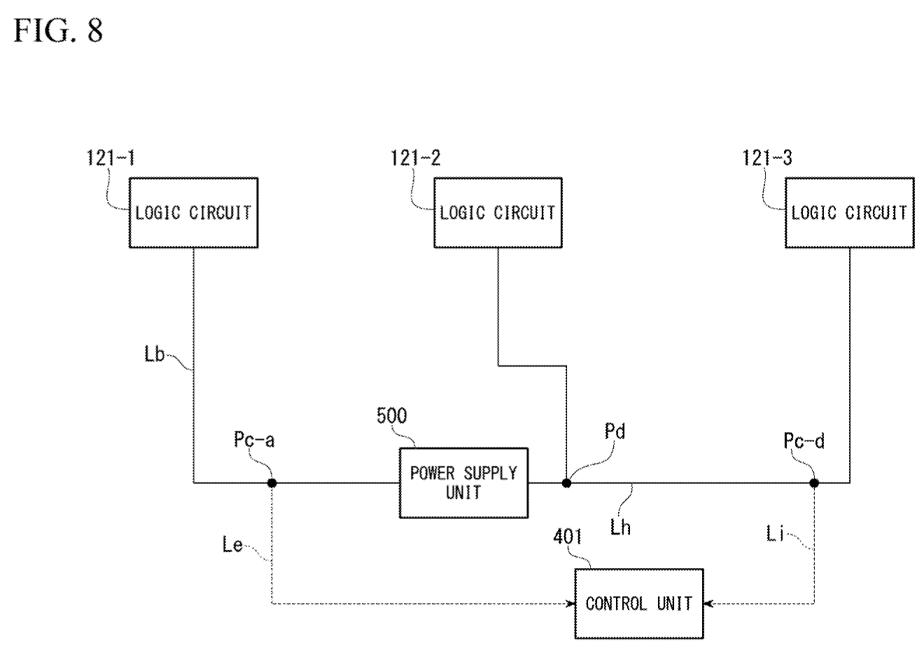

FIG. 8 indicates a second example of the positions of SVdd nodes in a modification example. In the example in FIG. 8 also, in order to simplify the explanation, there are three logic circuits 121 connected to the power supply unit 500. In the example in FIG. 8, the three logic circuits 121-1 to 121-3 are connected to the power supply unit 500. The Vdd line connecting the logic circuit 121-1 with the power supply unit 500 is not a conductive line having a portion in common with the Vdd lines connecting the other logic circuits 121 with the power supply unit 500.

On the other hand, the Vdd line connecting the logic circuit 121-2 with the power supply unit 500 has a portion in common with the Vdd line connecting the logic circuit 121-2 with the power supply unit 500. There are two SVdd nodes, these being the SVdd node Pc-a and the SVdd node Pc-d.

The SVdd node Pc-d is an SVdd node on the Vdd line connecting the logic circuit 121-2 and the logic circuit 121-3 with the power supply unit 500. The respective SVdd nodes are connected to the control unit 401 by SVdd lines.

Therefore, an SVdd signal flowing through the SVdd line connecting the SVdd node Pc-a with the control unit 401 and an SVdd signal flowing through the SVdd line connecting the SVdd node Pc-d with the control unit 401 flow into the control unit 401 in this case. The control unit 401 performs a determination process for each SVdd signal.

As a result thereof, the control unit 401 determines whether or not a digital operation voltage Vdd capable of driving the logic circuit 121-1 is being applied to the logic circuit 121-1. Additionally, the control unit 401 determines whether or not digital operation voltages Vdd capable of driving each of the logic circuit 121-2 and the logic circuit 121-3 are being applied to the logic circuit 121-2 and the logic circuit 121-3.

In the case of the example in FIG. 8, if the only determination target is, for example, the logic circuit 121-1, the control unit 401 does not need to perform a determination process regarding the logic circuit 121-2 and the logic circuit 121-3.

The conductive line Lh in the example in FIG. 8 is an example of a Vdd line, and the conductive line Li is an example of an SVdd line.

In the case in which the thermal head 10 is provided with a plurality of logic circuits 121, each of the logic circuits 121 may be supplied electric power by branching a signal flowing out from the power supply unit 500 towards each of the logic circuits 121. The signal flowing out from the power supply unit 500 is a signal flowing through a Vdd line. The circuit in FIG. 5 and the circuit composed of the logic circuit 121-2, the logic circuit 121-3, and the power supply unit 500 in the circuit in FIG. 8 are examples of circuits in which power is supplied by branching in this way.

In such a case, an SVdd node may be located at a position before the branching of the signal flowing through the Vdd line. For example, in the example in FIG. 5, the node Pa is between the branch point Pb and the power supply unit 500. Therefore, in the example in FIG. 5, the SVdd node is positioned before the branching of the signal flowing through the Vdd line. In the example in FIG. 8 also, the node Pc-d may be positioned between the branch point Pd and the power supply unit 500. The branch point Pd is a branch point on the conductive line connecting the power supply unit 500 with the logic circuit 121-2 and the logic circuit 121-3, at which the signal flowing from the power supply unit 500 branches to the logic circuit 121-2 and to the logic circuit 121-3.

Although a number of embodiments of the present disclosure have been explained, these embodiments are presented as examples and are not intended to limit the scope of the present disclosure. These embodiments may be implemented in various other modes, and various omissions, substitutions, and changes can be made within a range not departing from the spirit of the disclosure. These embodiments and modifications thereof are included within the scope and spirit of the disclosure and are likewise included within the disclosure recited in the claims and within the range of equivalents thereof.

What is claimed is:

1. An image formation apparatus comprising:
a thermal head provided with a heat-generating body and a driver IC (integrated circuit) comprising at least one logic circuit that controls operations of the heat-generating body; and
a controller configured to perform a determination regarding whether or not a digital operation voltage Vdd, capable of driving the at least one logic circuit, is being applied to the at least one logic circuit.

2. The image formation apparatus according to claim 1, wherein:
the controller is configured to perform the determination based on an SVdd signal, which is a signal flowing through a conductive line connecting the controller with an SVdd node, the SVdd node being a prescribed position on a conductive line connecting the at least one logic circuit with a power supply that outputs electric power to the at least one logic circuit.

3. The image formation apparatus according to claim 2, wherein:
the controller is configured to perform the determination based on a signal level of the SVdd signal.

4. The image formation apparatus according to claim 2, wherein:
the controller is configured to perform the determination based on whether or not a signal level of the SVdd signal is equal to or higher than a prescribed magnitude.

5. The image formation apparatus according to claim 2, wherein:
the thermal head comprises a buffer that converts the digital operation voltage Vdd to a detection signal.

6. The image formation apparatus according to claim 5, wherein:
the buffer comprises a pull-down circuit.

7. The image formation apparatus according to claim 2, wherein:
the SVdd node is set to be on the thermal head.

8. The image formation apparatus according to claim 1, wherein:
the controller is configured to output a result of the determination regarding whether or not the digital operation voltage Vdd is being applied to the at least one logic circuit, to a prescribed output destination that is controllable by the controller.

9. The image formation apparatus according to claim 8, wherein:
the controller is configured to control operations of a display unit indicating the output destination, and cause the display unit to display a result of the determination.

10. The image formation apparatus according to claim 8, wherein:
the controller is configured to control operations of a speaker indicating the output destination, and cause the speaker to output a result of the determination by speech.

11. The image formation apparatus according to claim 1, wherein:
the thermal head has a plurality of logic circuits; and
the controller is configured to perform the determination for each of the plurality of logic circuits which are determination targets.

12. The image formation apparatus according to claim 1, wherein:
the thermal head comprises a plurality of the logic circuits;
each of the plurality of logic circuits is supplied with electric power, by a signal flowing from a power supply that outputs the electric power, branching towards each of the plurality of logic circuits; and
an SVdd node, which is a prescribed position on a conductive line connecting the plurality of logic circuits with the power supply that outputs the electric power to the plurality of logic circuits, is positioned before the branching of the signal.

13. The image formation apparatus according to claim 12, wherein:
the controller is configured to perform the determination on the plurality of logic circuits, based on an SVdd signal that is a signal flowing in a conductive line connecting the controller with the SVdd node that is positioned before the branching of the signal.

14. The image formation apparatus according to claim 1, wherein:
the thermal head comprises a plurality of the logic circuits;
each of the plurality of logic circuits is supplied with electric power, by a signal flowing from a power supply that outputs the electric power, branching towards each of the plurality of logic circuits; and
the controller is configured to perform the determination on each of the plurality of logic circuits, based on respective SVdd signals that are signals flowing in respective conductive lines connecting the controller with respective SVdd nodes, which are prescribed positions on the respective conductive lines connecting the power supply with each of the plurality of logic circuits.

15. The image formation apparatus according to claim 1, wherein:
the thermal head comprises a plurality of the logic circuits;
each of the plurality of logic circuits is supplied with electric power, by a signal flowing from a power supply that outputs the electric power, branching towards each of the plurality of logic circuits; and
a single SVdd node, which is a prescribed position on a conductive line connecting the power supply with two or more logic circuits among the plurality of logic circuits, is positioned on one side after the branching of the signal towards the two or more logic circuits.

16. The image formation apparatus according to claim 15, wherein:
the controller is configured to perform the determination on the two or more logic circuits, based on an SVdd signal that is a signal flowing in the conductive line connecting the controller with the single SVdd node, which is positioned on the one side after the branching of the signal towards the two or more logic circuits.

17. The image formation apparatus according to claim 1, wherein:
the thermal head comprises a plurality of the logic circuits;
each of the plurality of logic circuits is supplied with electric power, by a signal flowing from a power supply that outputs the electric power, branching towards each of the plurality of logic circuits; and
a single SVdd node, which is a prescribed position on a conductive line connecting the power supply with two or more logic circuits among the plurality of logic circuits, is positioned before the branching of the signal towards the two or more logic circuits.

18. The image formation apparatus according to claim 17, wherein:
the controller is configured to perform the determination on the two or more logic circuits, based on an SVdd signal that is a signal flowing in a conductive line connecting the controller with the single SVdd node, which is positioned before the branching of the signal towards the two or more logic circuits.

19. An image formation apparatus comprising:
a thermal head provided with a heat-generating body and a driver IC (integrated circuit) comprising at least one logic circuit that controls operations of the heat-generating body;
at least one or more memory configured to store a command; and
at least one processor configured to execute the command, wherein
the at least one processor is configured to perform a determination regarding whether or not a digital operation voltage Vdd, capable of driving the at least one logic circuit, is being applied to the at least one logic circuit.

20. A control method for an image formation apparatus, which includes a controller and a thermal head provided with a heat-generating body and a driver IC (integrated circuit) comprising at least one logic circuit that controls operations of the heat-generating body, wherein the control method comprises:
performing a determination regarding whether or not a digital operation voltage Vdd, capable of driving the at least one logic circuit, is being applied to the at least one logic circuit.
